(19) United States
(12) Patent Application Publication
(10) Pub. No.: US 2005/0284410 A1
(43) Pub. Date: Dec. 29, 2005

(54) Apparatus for training, exercising & playing with a pet

(76) Inventor: Janet Lynn Brown-Smith, Plymouth, MI (US)

Correspondence Address: Janet Lynn Brown-Smith, 9109 Mayflower Dr., Plymouth, MI, 48170, US

(21) Appl. No.: 11/109,382

(22) Filed: Apr. 19, 2005

Related U.S. Application Data
(60) Provisional application No. 60/564,101, filed on Apr. 21, 2004.

(51) Int. Cl. A01K 29/00

(52) U.S. Cl. 119/707

(57) ABSTRACT

An apparatus for a pet that includes a rigid member having first and second ends and a flexible member having first and second ends. The first end of the flexible member is connected to the second end of the rigid member. An ergonomic handle is connected to the first end of the rigid member. An attachment device attaches a projectile to the second end of the flexible member. The ergonomic handle is configured to allow persons with limited mobility to move the projectile.

### RELATED APPLICATIONS

This application claims priority from U.S. Provisional Patent Application Ser. No. 60/564,101, filed Apr. 21, 2004.

### BACKGROUND OF INVENTION

The present invention relates to an apparatus for pets and more particularly to an apparatus for a pet having a tethered toy that may be whipped around from a standing or sitting position by a person with limited mobility.

One problem faced by many pet owners is that they do not have enough time or energy to walk their dogs for long periods of time, in order to meet their dogs' exercise needs. Therefore, many pet owners will use a tethered toy that may be whipped around to exercise their pets. However, these tethered toys have several drawbacks. One drawback is that some pet owners have difficulty gripping or holding the tethered toy because they have limited mobility in their hands or wrists. Another drawback with some toys is that the tethered toy cannot be removed to be clean or replaced with another toy. Yet another drawback is that some of the tethered toys are complicated and impractical. Still yet another drawback is that the length of some of tethered toys is not adjustable to accommodate different sized pets. Accordingly, a tethered toy that is simple and easily to operate by a person with limited mobility is needed.

### SUMMARY OF THE INVENTION

An object of the present invention to provide a tethered toy that includes an ergonomic handle that is easier to grip by most pet owners, including those with limited mobility. The ergonomic handle allows a person with limited hand and/or wrist motion to grip the handle and whip the apparatus around in order for the pet to chase the toy. Also, the invention can be easily used in a sitting position and does not require the owner to stand.

Another object of the invention is to provide a tethered toy that allows the attached toy to be easily removed for washing or replacing.

Another object of the present invention is to provide a tethered toy that allows the length of the tether to be adjusted to accommodate smaller dogs and smaller confined areas.

Another object of the present invention is to provide a simple durable tethered toy for exercising a pet.

The present invention provides an apparatus for training, exercising and playing with a pet that includes a rigid member having first and second ends and a flexible member having first and second ends. The first end of the flexible member is connected to the second end of the rigid member. An ergonomic handle is attached to the first end of the rigid member. An attachment device attaches a target projectile to the second end of the flexible member.

In one embodiment of the present invention, the ergonomic handle includes a gripping portion and a non-gripping portion opposite the gripping portion. The gripping portion and the non-gripping portion form a hand passage for receiving the fingers and palm of the user. The gripping portion may include indentions for receiving the users fingers. The gripping portion forms an arcuate shape and the non-gripping portion includes a bore for receiving the first end of the rigid member. Alternatively, the non-gripping portion forms an arcuate shape and the gripping portion includes a bore for receiving the first end of the rigid member.

In another embodiment, the rigid member is a rod having a fiberglass core encased in a tightly braided nylon cover. Preferably, the length of the rigid member is approximately 48 inches or 122 cm. The flexible member is a nylon rope having a length of approximately 36 inches or 91 cm. The target projectile is attached to the end of the flexible member by the attachment device that includes a loop located at the second end of the flexible member and a strap extending through the loop and around the projectile. A hook and loop fastener may close the strap around the projectile. The attachment device allows the projectile to be easily removed or replaced.

In another embodiment of the present invention, the apparatus may include a reduction device for reducing the length of the flexible member. The reduction device may be a hook and loop fastener attached to a portion of the rigid member. To shorten the flexible member, the hook and loop fastener is wrapped around desired portion of the flexible member and then wrapped around the rigid member. The reduction device allows the flexible member to be temporarily shortened to a desired length to accommodate smaller pets and smaller confined areas.

These and other features and advantages of the present invention will be more fully understood from the following description of certain embodiments of the invention, taken together with the accompanying drawings.

### BRIEF DESCRIPTION OF DRAWINGS

In the drawings:

FIG. 1 is a perspective view of an apparatus for a pet in accordance with one embodiment of the present invention;

FIG. 2 is a side view of an ergonomic handle of the apparatus of FIG. 1;

FIG. 3 is a side view of an ergonomic handle of an apparatus in accordance with another embodiment of the present invention;

FIG. 4 is a cross-sectional view of a rigid member of the apparatus of FIG. 1;

FIG. 5 is a top view of an attachment device of the apparatus of FIG. 1; and

FIG. 6 is an enlarged view of a reduction device of the apparatus of FIG. 1.

### DETAILED DESCRIPTION

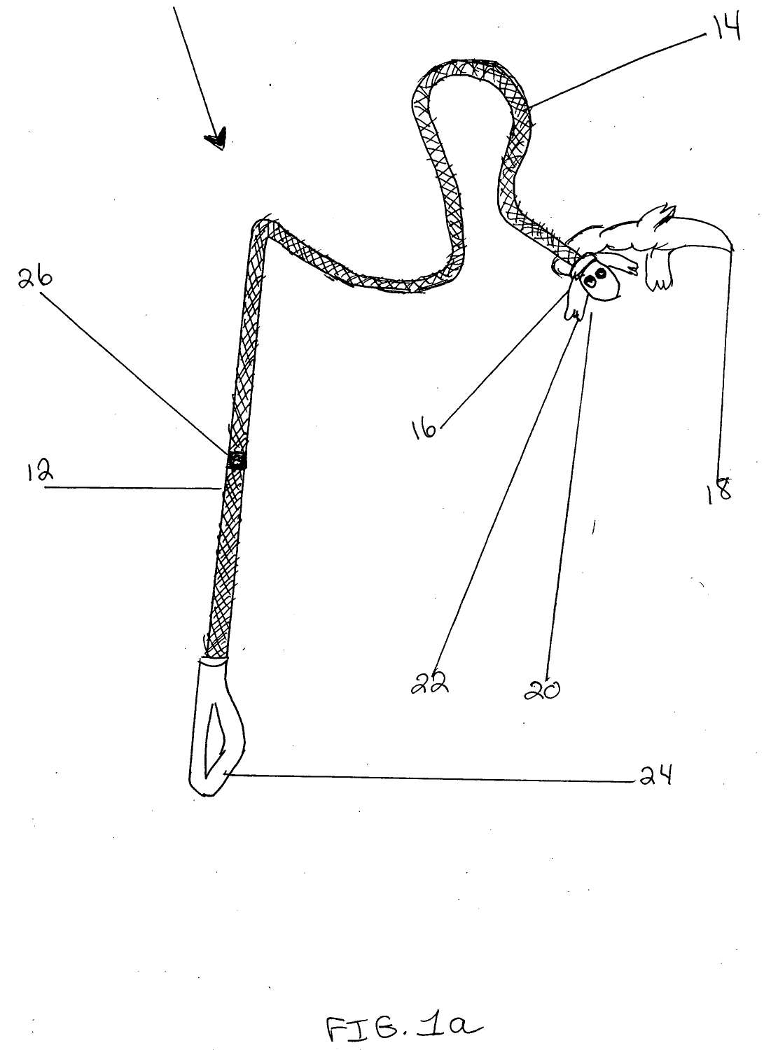

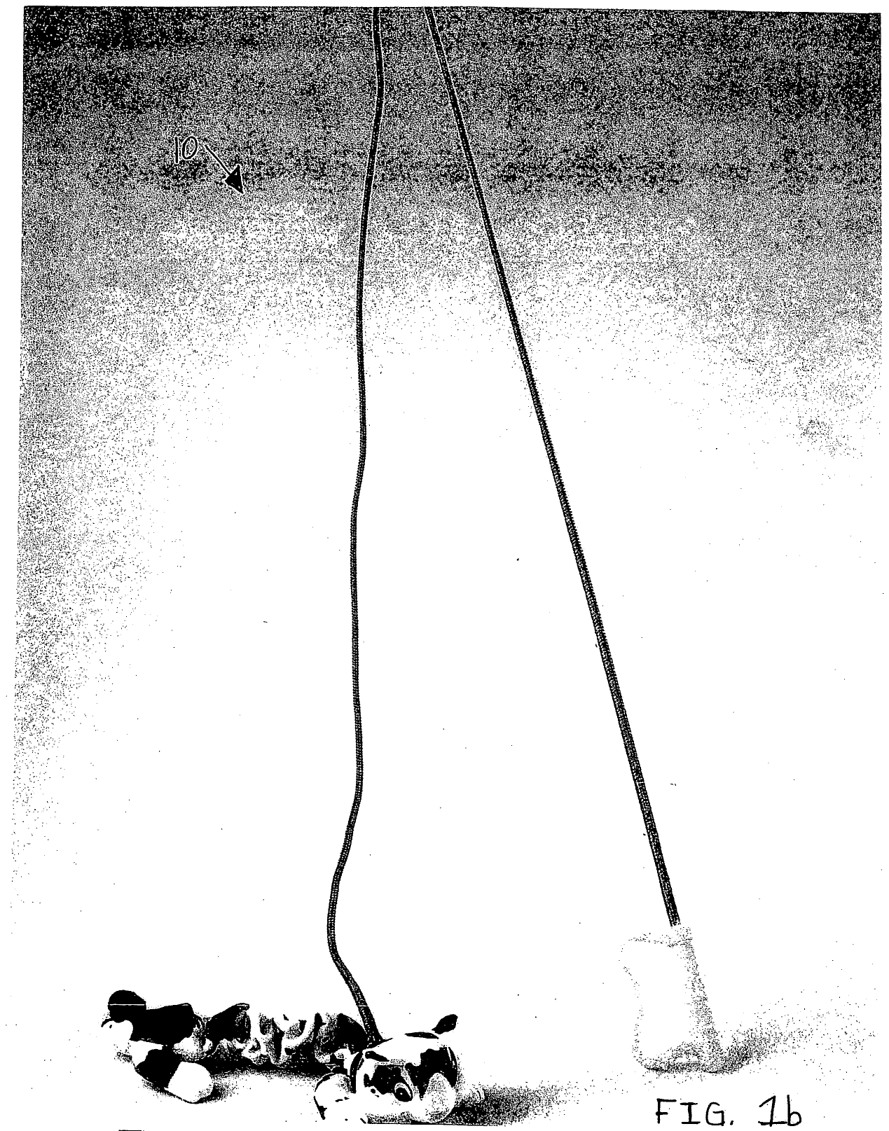

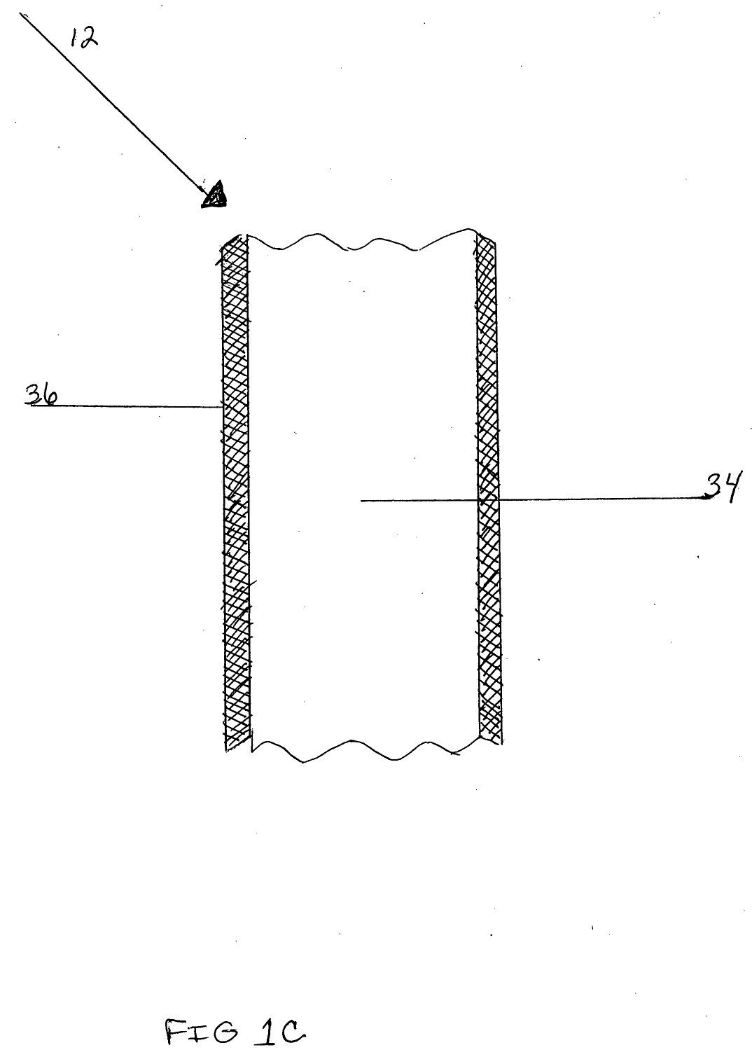

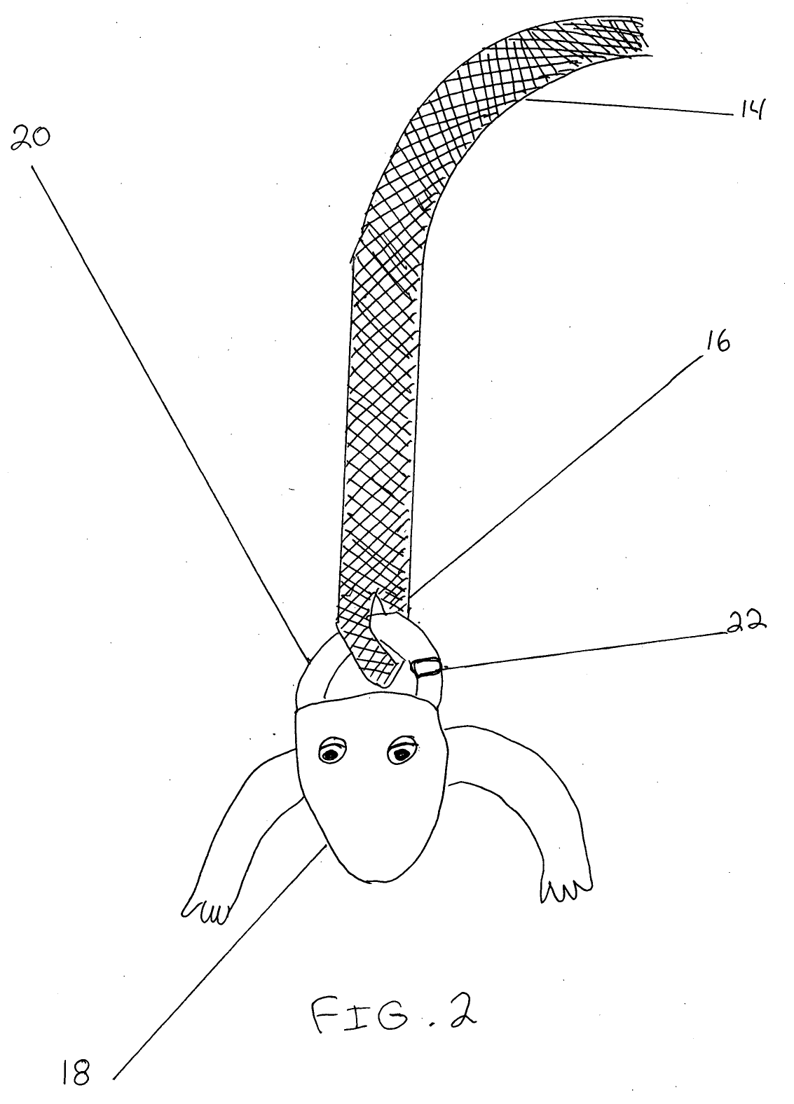

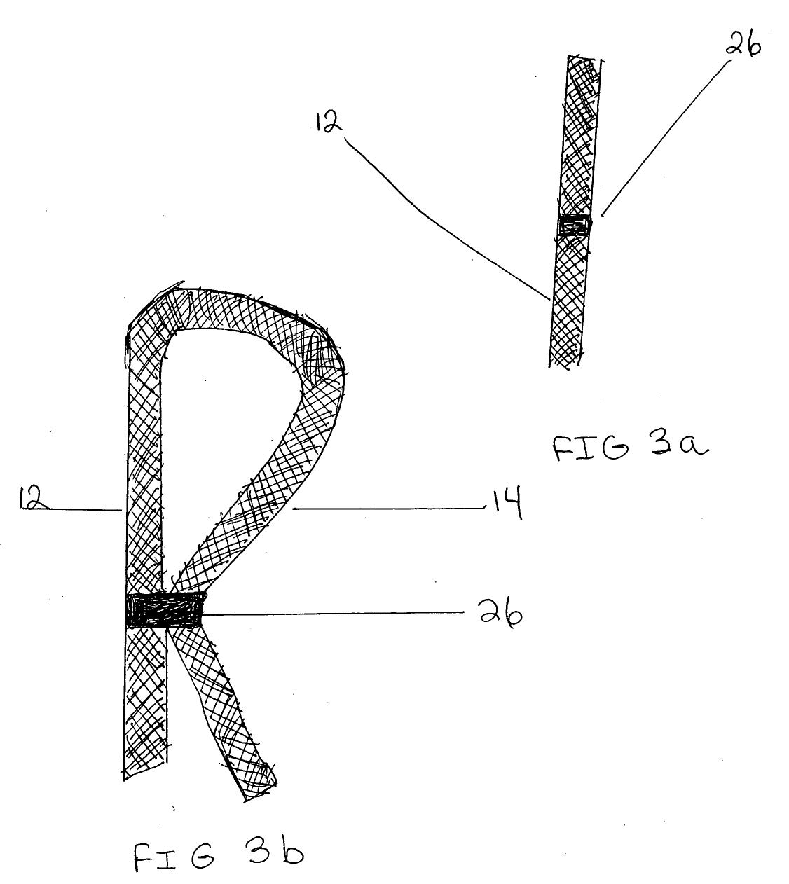

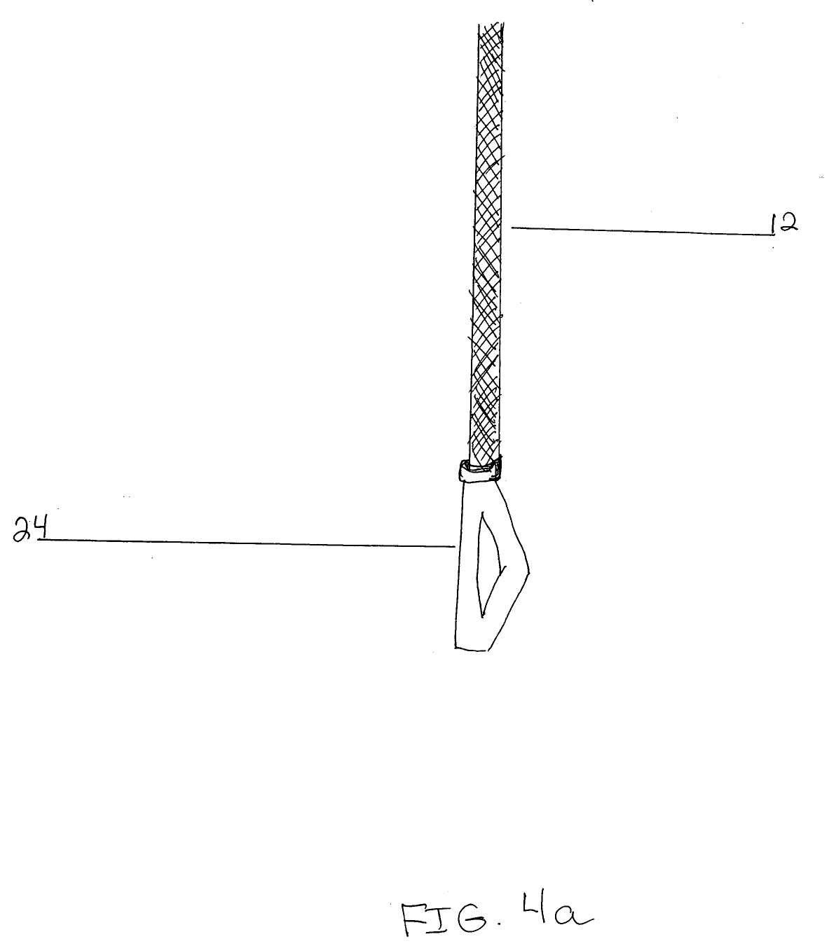

FIGS. 1, 2 and 4-6 illustrate an apparatus 10 for exercising, playing or training a pet in accordance with one embodiment of the present invention. The apparatus 10 generally includes an ergonomic handle 12, a rigid member 14, a flexible member 16 and an attachment device 18 for attaching a target projectile 20 or toy to an end of the flexible member 16. Looking to FIGS. 1 and 2, the handle 12 includes a gripping portion 22 and a non-gripping portion 24 located opposite the gripping portion 22. The gripping portion 22 has a generally arcuate shape and a plurality of indentions 26 for receiving the fingers of the user. A hand passage 28 is provided between the gripping portion 22 and the non-gripping portion 24. The hand passage 28 being large enough to accommodate free passage of user's fingers and palm. The non-gripping portion 24 includes a bore 30 for receiving the rigid member 14. Alternatively, the handle 12 includes a non-gripping portion 32 having a generally arcuate shape and a gripping portion 34 including a bore 36 for receiving the rigid member 14, as shown in FIG. 3. The gripping portion 34 has a plurality of indentions 38 for receiving the fingers of the user. The handle 12 may be made of a plastic, soft rubber material or other such material.

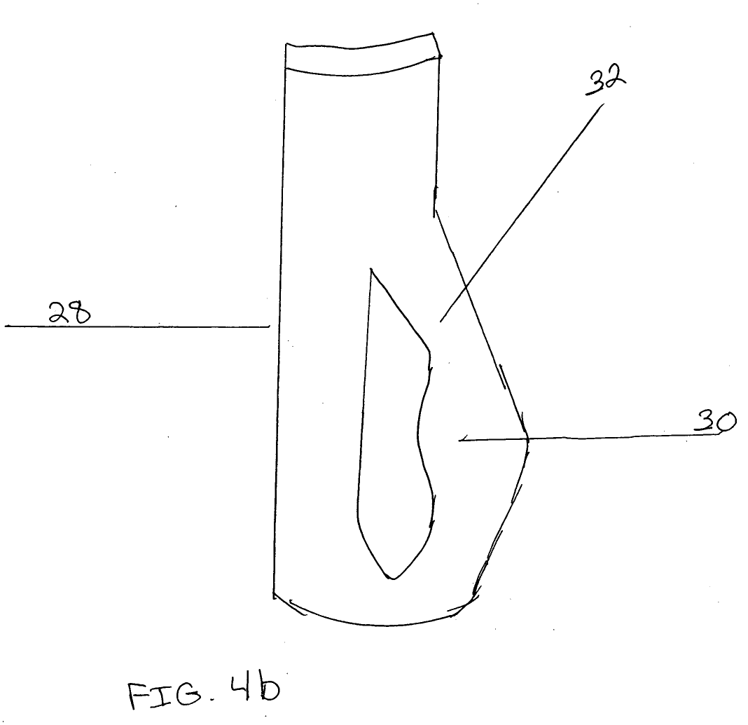

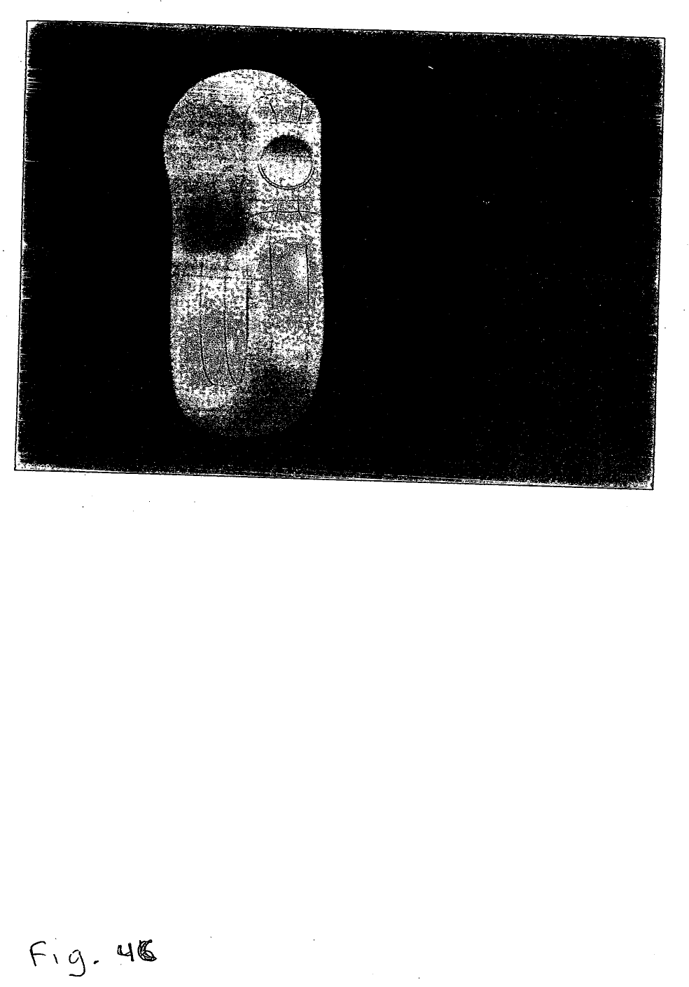

Looking to FIG. 1, the rigid member 14 includes first and second ends 40, 42. The first end 40 is connected to the handle 12 and the second end 42 is connected to the flexible member 16. In this embodiment, the rigid member 14 is a rod having a length of approximately 48 inches or 122 cm. The rigid member 14 is includes a fiberglass core 44 and encased by a tightly braided nylon cover 46, see FIG. 4. The flexible member 16 includes first and second ends 48, 50. The first end 48 is connected to the second end 50 of the rigid member 14 and the second end 50 has a loop 52. In this embodiment, the flexible member 16 is a rope made from nylon or other durable material and has a length of approximately 36 inches or 91 cm.

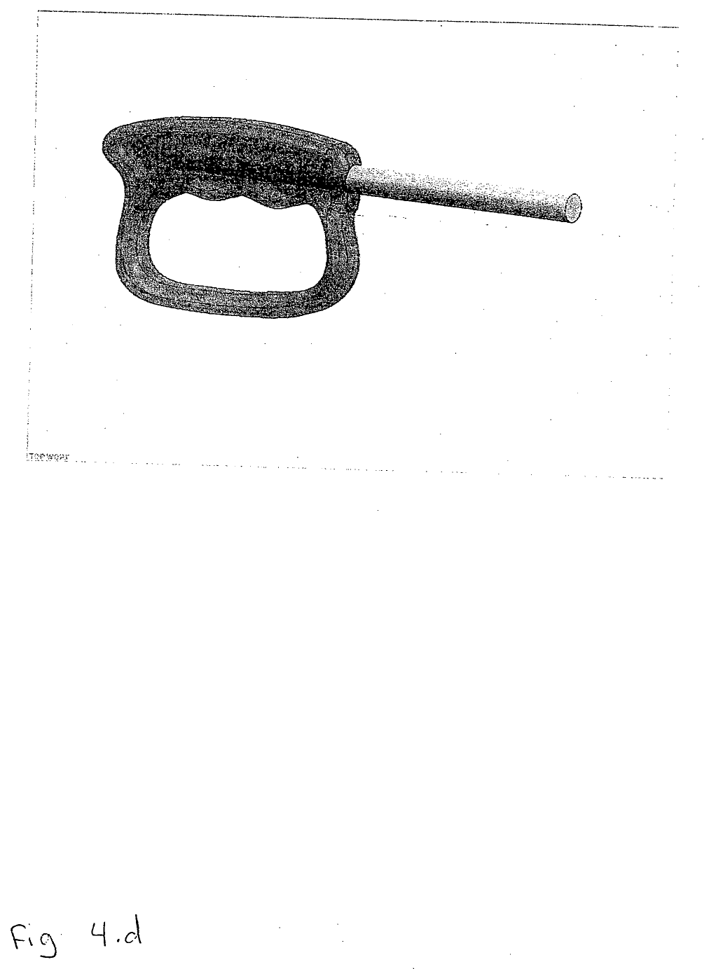

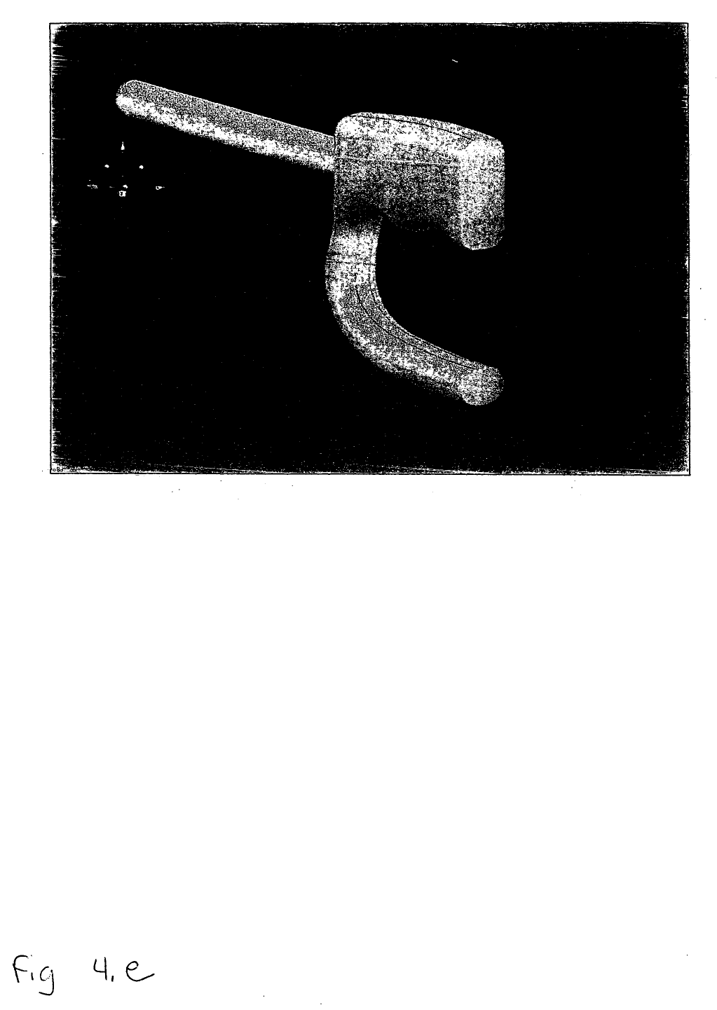

Looking to FIGS. 1 and 5, the attachment device 18 includes a strap 54 for attaching the target projectile 20 to the second end 50 of the flexible member 16. In this embodiment, the target projectile 20 is a pet toy. To attach the target projectile 20 to the flexible member 16, the strap 54 is inserted through the loop 52 and wrapped around the target projectile 20. The strap 54 is closed around the projectile 20 with a hook and loop fastener 56. The strap 54 is made of plastic or other durable material.

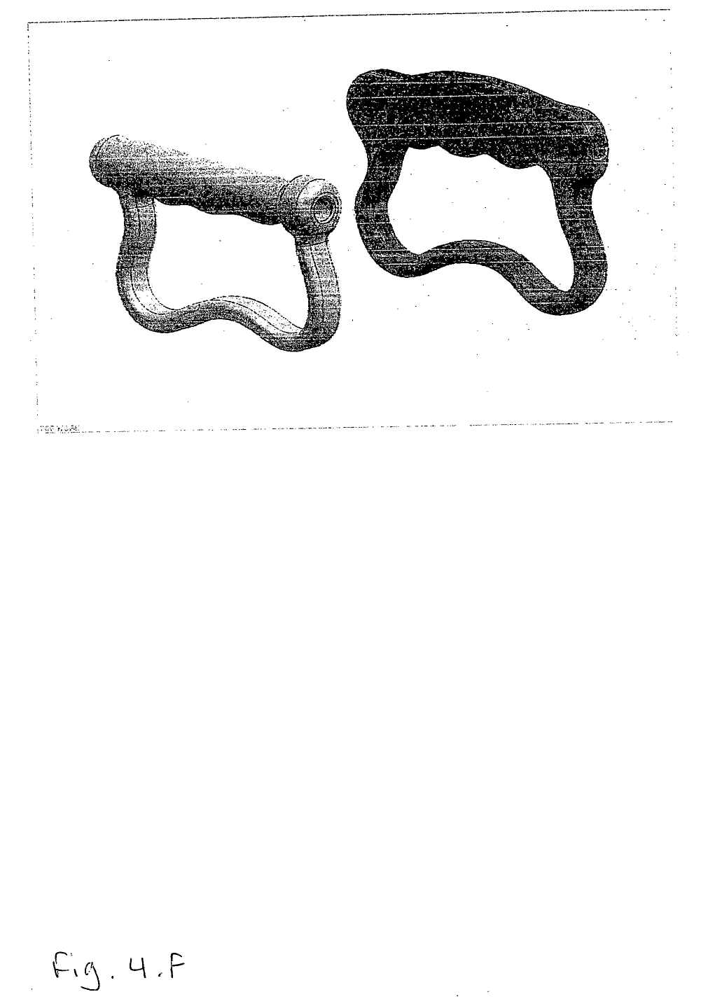

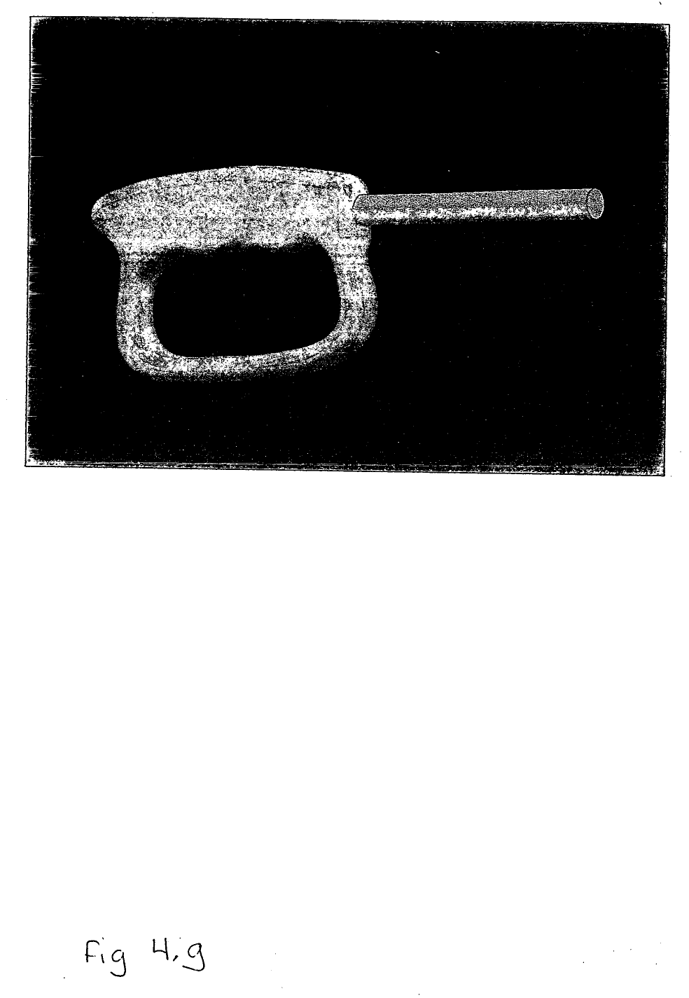

Looking to FIG. 6, in another embodiment, the apparatus 10 includes a reduction device 58 that reduces the length of the flexible member 16. The reduction device 58 may be a hook and loop fastener 60 attached to a portion of the rigid member 14. To shorten the flexible member 16, the hook and loop fastener 60 is wrapped around the desired portion of the flexible member 16 and then wrapped around the rigid member 14 as shown in FIG. 6. When the reduction device 58 is not in use, it is wrapped around the rigid member 14. The reduction device 58 allows the flexible member 16 to be temporarily shortened to a desired length to accommodate smaller pets and smaller confined areas.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

1. An apparatus for training, exercising and playing with a pet comprising:
a rigid member having first and second ends;
a flexible member having first and second ends, the first end of the flexible member connected to the second end of the rigid member;
an ergonomic handle connected to the first end of the rigid member; and
an attachment device for attaching a projectile to the second end of the flexible member,
the ergonomic handle configured to allow persons with limited mobility to move the projectile.

2. The apparatus of claim 1, wherein the ergonomic handle includes a gripping portion and a non-gripping portion opposite the gripping portion, the gripping portion and a non-gripping portion form a hand passage therebetween, one of the gripping and non-gripping portions forming an arcuate shape.

3. The apparatus of claim 2, wherein one of the gripping portion and the non-gripping portion of the handle includes a bore for receiving the first end of the rigid member.

4. The apparatus of claim 1, wherein the rigid member is made of a fiberglass core and a tightly-braided nylon cover encasing the fiberglass core.

5. The apparatus of claim 1, wherein the length of the rigid member is approximately 48 inches.

6. The apparatus of claim 1, wherein the flexible member is made of a nylon rope.

7. The apparatus of claim 1, wherein the length of the flexible member is approximately 36 inches.

8. The apparatus of claim 1, wherein the attachment device includes a loop located at the second end of the flexible member and a strap extending through the loop and around the projectile to attach the projectile to the apparatus.

9. The apparatus of claim 1, further comprising a reduction device for reducing a length of the flexible member.

10. The apparatus of claim 9, wherein the reduction device includes hook and loop fastener attached to the rigid member to attach a portion of the flexible member to the rigid member.
